(19) United States
(12) Patent Application Publication
(10) Pub. No.: US 2006/0068078 A1
(43) Pub. Date: Mar. 30, 2006

(54) Polyglycerin fatty acid esters and emulsified or solubilized compositions comprising them

(75) Inventor: Masahiko Ishitobi, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: MITSUBISHI CHEMICAL CORPORATION, Tokyo (JP)

(21) Appl. No.: 11/246,950

(22) Filed: Oct. 11, 2005

Related U.S. Application Data
(63) Continuation of application No. PCT/JP04/08026, filed on Jun. 9, 2004.

(30) Foreign Application Priority Data
Jun. 26, 2003 (JP) 2003-183423

(51) Int. Cl. A23D 9/00

(52) U.S. Cl. 426/611

(57) ABSTRACT

The present invention relates to a polyglycerin fatty acid esters whose constituting fatty acid comprises not less than 70% by weight of palmitic acid and whose cloud point in a 7 wt % Na₂SO₄ solution at a concentration of 1% by weight is not lower than 55° C but not higher than 100° C. The said polyglycerin fatty acid esters have excellent O/W type fine emulsifying properties even under an acidic condition, capable of maintaining good flavor and also high in stability at low temperatures and suited for forming emulsified or solubilized compositions.

### TECHNICAL FIELD

The present invention relates to polyglycerin fatty acid esters and emulsified or solubilized compositions comprising such esters. More particularly, the present invention relates to polyglycerin fatty acid esters having excellent O/W type fine emulsifying properties even under an acidic condition, capable of maintaining good flavor and also high in stability at low temperatures and suited for forming emulsified or solubilized compositions; emulsifying or solubilizing agents comprising such esters; and emulsified or solubilized compositions comprising a polyglycerin fatty acid ester, a nonaqueous substance and a polyhydric alcohol and/or water.

### BACKGROUND ART

Polyglycerin fatty acid esters (which may hereinafter be abbreviated as “PoGE”) are known as a surface active agent which has been officially approved as a food additive. In addition to their prevalent use as an emulsifier for foods, these esters are also widely utilized recently for medicines, cosmetics and other industrial products. It is possible to obtain PoGE with diversified properties ranging from hydrophilic to lipophilic by controlling the average polymerization degree of polyglycerin (which may hereinafter be abbreviated as “PoG”) and chain length and degree of substitution of the component fatty acid.

It has been disclosed that PoGE with a polyglycerin polymerization degree of not less than 6 and comprising a fatty acid with a carbon number of 12 to 22 were useful for solubilizing oil-soluble substances. (See Patent Literature 1). Particularly those comprising an unsaturated fatty acid with a carbon number of 12 to 22 have excellent acid, salt and heat resistance which is not seen in other emulsifying agents for foods and are useful for O/W type emulsification of food additives such as, typically, sauce, dressing and mayonnaise. (See Patent Literature 2). Especially a PoGE composition whose cloud point in an 8 wt % Na₂SO₄ solution at a concentration of 1% by weight is 65 to 90° C. is highly useful for such emulsification. (See Patent Literature 3).

Also, a solubilizaing agent comprising PoGE in which 70% by weight of its component PoG has a polymerization degree of not less than 8, with the average polymerization degree being 18 to 22, has been disclosed. (See Patent Literature 4).

Patent Literature 1: Japanese Patent Application Laid-Open (KOKAI) No. 62-250941

Patent Literature 2: Japanese Patent Application Laid-Open (KOKAI) No. 61-234920

Patent Literature 3: Japanese Patent Application Laid-Open (KOKAI) No. 2000-287631

Patent Literature 4: Japanese Patent Application Laid-Open (KOKAI) No. 11-124563

### DISCLOSURE OF THE INVENTION

### PROBLEM TO BE SOLVED BY THE INVENTION

Polyglycerin unsaturated fatty acid esters are generally supposed to have higher emulsifying performance than polyglycerin saturated fatty acid esters, but the smell and taste peculiar to the unsaturated fatty acids give a baleful effect to the flavor of the compositions. Generally, polyglycerin unsaturated fatty acid esters have acid resistance and are effective for O/W type emulsification of the food additives such as sauce, dressing and mayonnaise, and their emulsifying performance under an acid condition is believed to be higher than that of polyglycerin saturated fatty acid esters, but the smell and taste peculiar to the unsaturated fatty acids are the negative factors for their practical use.

Further, polyglycerin saturated fatty acid esters have the problem that if the chain length of the constituting fatty acid is too long, the esters lower in water solubility, causing precipitation of the emulsified substance during preservation, while if the chain length is too small, the esters are unable to exhibit their emulsifying performance to the full measure.

There is also the problem that a too high average polymerization degree of the component PoG is unfavorable for use of the esters in foods since its safety has not yet been confirmed.

### MEANS FOR SOLVING THE PROBLEM

As a result of the present inventors' earnest studies with the object of providing PoGE's which are cleared of the above problems, it has been found that PoGE's containing palmitic acid in a high ratio as the component fatty acid and having a cloud point not lower than a specific temperature have a good balance of emulsifying performance and stability at low temperatures and can provide good commercial PoGE products with excellent flavor.

Thus, in an aspect of the present invention, there are provided polyglycerin fatty acid esters whose constituting fatty acid comprises not less than 70% by weight of palmitic acid and whose cloud point in a 7 wt % Na₂SO₄ solution at a concentration of 1% by weight is not lower than 55° C. but not higher than 100° C.

In another aspect of the present invention, there are provided emulsifying or solubilizing agents comprising the said polyglycerin fatty acid esters.

In still another aspect of the present invention, there are provided emulsified or solubilized preparations comprising a polyglycerin fatty acid ester such as mentioned above, a nonaqueous substance and a polyhydric alcohol and/or water.

In yet another aspect of the present invention, there are provided emulsified or solubilized compositions comprising a polyglycerin fatty acid ester such as mentioned above, a nonaqueous substance and a polyhydric alcohol and/or water.

### EFFECT OF THE INVENTION

The polyglycerin fatty acid esters of the present invention produce an excellent effect for O/W type fine emulsification even under an acid condition, can provide the emulsified or solubilized compositions with good flavor, and remain free of precipitation even during preservation at a low temperature.

### BEST MODE FOR CARRYING OUT THE INVENTION

A detailed description of the present invention is given below.

[Polyglycerin Fatty Acid Esters]

In the polyglycerin fatty acid esters according to the present invention, not less than 70% by weight of the component fatty acid is constituted by palmitic acid. The higher the ratio of palmitic acid in the component fatty acid, the more preferable; the ratio of palmitic acid is preferably not less than 80% by weight, more preferably not less than 90% by weight, especially preferably not less than 95% by weight. The fatty acids which can be used with palmitic acid in the esters are not specified in the present invention, but such fatty acids are usually those with a carbon number of 10 to 18.

Average polymerization degree of polyglycerin in the polyglycerin fatty acid esters according to the present invention is usually 4 to 17, preferably 4 to 12. A too low average polymerization degree of polyglycerin leads to a reduction of emulsifying or solubilizing activity of the esters while a too high average polymerization degree thereof is unfavorable for use relating to foods in view of safety.

The cloud point of the polyglycerin fatty acid esters according to the present invention in a 7 wt % Na₂SO₄ solution at a concentration of 1% by weight of the ester is not lower than 55° C. but not higher than 100° C. If the cloud point is too low, the emulsifying or solubilizing performance of the esters is accordingly lessened.

(Cloud Point)

Concerning the cloud point, a method of utilizing the cloud point of polyglycerin fatty acid esters for the management of their products has been disclosed, and its advantageous points are described as follows (Japanese Patent Application Laid-Open (KOKAI) No. 9-157386). Various chemical analytical methods have been used for the analyses of PoGE. For instance, acid value, ester value or hydroxyl value has been often used to determine the esterification degree or residual amount of fatty acid. Also, evaluation methods by the analysis of ignition residue or other means have been used for knowing the amount of soap or residual catalyst.

The PoG skeleton of the hydrophilic moiety of PoGE is a polycondensate of glycerin, so that these esters are the compositions having a distribution of polymerization degree and contain not only linear polymers but also branched and cyclic polymers. Generally, PoG is increased in viscosity as its polymerization degree becomes higher, so that purification works such as separation of cyclic polymers from the polycondensate are very difficult to carry out, and PoGE obtained as a reaction product by esterifying the hydroxyl groups of PoG with a fatty acid are usually the compositions containing PoGE with various esterification degrees differing in PoG skeleton and unreacted PoG. Further, in the esterification reaction product, there may be contained soap, which is a by-product formed by the reaction of the alkali catalyst used for the reaction and the starting material fatty acid, as well as the unreacted fatty acid in case where the esterification reaction is insufficient or the fatty acid is used in excess of stoichiometrical quantity. Thus, since PoGE is a complex mixture, the determined properties such as emulsion stability may differ widely from sample to sample even if the measured values of average esterification degree of PoGE are close or equal to each other, so that it has been impossible to definitely know the properties only by the conventional chemical analytical means such as determination of average esterification degree or unreacted PoG, giving rise to difficulties in property evaluations.

As means for property evaluation of surfactants other than the chemical analyses mentioned above, there is known, for example, a method using cloud point in the polyoxyethylene-based nonionic surfactant or such derived from ethylene oxide (Oils and Fats Terminological Dictionary, complied by Japan Oleochemical Society (pub. by Saiwai Shobo Pub. Co.)). Generally, cloud point is defined as the temperature at which the following phenomenon takes place: an aqueous solution of a nonionic surfactant derived from ethylene oxide separates into two phases and becomes heterogeneous with rise of temperature, and the system again becomes homogeneous with drop of temperature (Oils and Fats Terminological Dictionary).

In the polyoxyethylene-based surfactants, there exists an interrelation between cloud point and average polymerization degree of hydrophilic group polyoxyethylene chain, and it is known that cloud point elevates proportionally with rise of hydrophilicity caused by increase of average polymerization degree. For producing an objective surfactant, the reaction conditions were selected so that the addition polymerization degree of ethylene oxide would fall within a proper range by determining the cloud point. It has been explained that such a producing operation is possible because hydrophilicity of the ether groups existing in this type of surfactant ethylene oxide polymers decreases with rise of temperature.

In the case of PoGE, on the other hand, since its hydrophilic moiety comprises a polycondensate of glycerin, there not only exist both hydroxyl group and ether group at the same time unlike the oxyethylene chains, but there also takes place branching condensation or cyclic polycondensation due to the presence of hydroxyl groups, so that PoGE are of a very complex composition and determination of their cloud point has been considered difficult.

It has become possible, however, to determine the cloud point of PoGE by adding a salt and/or a polyhydric alcohol to PoGE to prepare a homogeneous phase solution and elevating the temperature of this solution to form a heterogeneous phase solution.

Although no definite difference can be detected among the PoGE samples by the conventional chemical analytical methods such as analyses of acid value, ester value, hydroxyl value and ignition residue mentioned above, a clear difference is manifested in cloud point. Since there is strong interrelation between the PoGE functions such as emulsifying or solubilizing performance and cloud point, it is very beneficial to use cloud point for the PoGE product management (News Letter, 1998, 23(1), 10-13).

(Methods for Determination of Cloud Point)

For determination of cloud point, usually, it is necessary to make measurement after dissolving a polyglycerin fatty acid ester in a 1 to 30 wt % sodium chloride or sodium sulfate solution, and the conditions of measurement vary depending on the solubility of the specimen. In the case of the present invention, first a polyglycern fatty acid ester is dispersed in a 7 wt % sodium sulfate solution to a concentration of 1% by weight, and the solution is stirred while heating to form a homogeneous solution. The obtained polyglycerin fatty acid ester solution is varied in temperature stepwise, 2 to 5° C. each time, in the range between 0 and 100° C., and after shaking at a fixed temperature, the solution is allowed to stand and the temperature at which the polyglycerin fatty acid ester is separated as an oil or gel to form a heterogeneous solution is measured. This transformation from homogeneous to heterogeneous state is called “cloud point phenomenon,” and the temperature at which this transformation occurs is called “cloud point.” In the present invention, this cloud point is determined. The temperatures outside the range of 0 to 100° C. are disregarded because when the temperature is below 0° C., it may become lower than the melting point of ice while when the temperature exceeds 100° C., it may become higher than the boiling point of water, so that at these temperatures it is difficult to correctly observe the condition of the solution, making it hard to determine the cloud point.

(Cloud Point of PoGE of the present invention)

The polyglycerin fatty acid esters according to the present invention have such a property that their cloud point in a 7 wt % sodium sulfate solution at a concentration of 1% by weight is not lower than 55° C. but not higher than 100° C. If the cloud point is too low, hydrophobicity of the esters becomes high to hinder stable formation of a fine emulsified composition, causing a drop of transmittance of the produced emulsified composition. There also takes place precipitation of PoGE itself during preservation of the emulsified composition. The higher the cloud point, the more preferable; it is preferably not lower than 70° C., more preferably not lower than 80° C., even more preferably not lower than 90° C.

The amount of the unreacted polyglycerin contained in the polyglycerin fatty acid ester is preferably as small as it can be; usually it is not more than 80% by weight, preferably not more than 60% by weight.

The average esterification rate of the polyglycerin fatty acid ester (ratio of the esterified hydroxyl groups in the whole hydroxyl groups of PoG) is usually not less than 10% but not more than 30%, preferably not less than 10% but not more than 20%.

(Production of Polyglycerin Fatty Acid Esters)

Various methods are known for the production of polyglycerin fatty acid esters, but they can be roughly divided into the following three types: (1) direct esterification of polyglycerin and fatty acids or their compounds (fatty acids, fatty acid chloride, etc.); (2) ester exchange between polyglycerin and fatty acid methyl ester or oil or fat; (3) addition polymerization of glycidol and fatty acids or their compounds (fatty acids, fatty acid monoglyceride, etc.). Industrially, direct esterification of polyglycerin and fatty acids is prevalently used.

For the production of polyglycerin, industrially a method comprising dehydration condensation reaction of glycerin is widely used, but there are also known the methods comprising polycondensation reaction of epichlorohydrin or addition reaction of glycidol. In the present invention, dehydration condensation reaction of glycerin or a method using glycidol as starting material is preferably used.

In the dehydration condensation reaction of glycerin, polyglycerin can be obtained usually by heating glycerin to a high temperature of 200° C. or more while blowing into it an inert gas such as nitrogen gas after addition of an alkali catalyst. The reaction time is usually 3 to 10 hours.

In the method using glycidol as starting material, there are available, for instance, a process in which glycidol is subjected to an addition reaction according to the objective polymerization degree by using a phosphoric catalyst in an amount of 0.01 to 10% by weight based on glycerin, and a process in which glycidol is reacted according to the objective polymerization degree with a carboxylic acid such as acetic acid, and then the carboxylic acid is removed by hydrolysis. The addition reaction is usually carried out by adding glycidol piecemeal to the reaction system at usually 80 to 140° C. for a period of usually 3 to 10 hours, preferably in a stream of an inert gas such as nitrogen gas. After the completion of the reaction, the phosphoric catalyst and residual carboxylic acid are neutralized with an alkali and dehydration precipitated. The reaction product is purified by suitable means such as diatomaceous earth filtration according to the purpose of use of the product. The resultantly obtained polyglycerin is a viscous liquid with little tinting.

A polyglycerin fatty acid ester used in the present invention can be obtained by a direct esterification reaction of polyglycerin and a fatty acid, which is carried out by using an alkali catalyst in an amount of 0.001 to 3% by weight, preferably 0.001 to 0.05% by weigbht, more preferably 0.001 to 0.01% by weight, based on the starting material (total amount of polyglycerin and fatty acid), at a temperature of 150 to 300° C., preferably 180 to 260° C.

If the amount of the alkali catalyst used is below the above-defined range, the esterification reaction is hard to proceed and a long time is required for completing the reaction. On the other hand, if the catalyst amount exceeds the above range, there tend to arise troubles such as tinting of the product and the undesired polymerization of the starting material PoG.

As the alkali catalyst, there can be used, for instance, potassium carbonate, sodium carbonate, potassium hydroxide and sodium hydroxide. The higher the content of palmitic acid in the fatty acid, the more preferable; it is usually not less than 70% by weight, preferably not less than 80% by weight, more preferably not less than 90% by weight, even more preferably not less than 95% by weight.

The reaction is usually carried out by supplying polyglycerin, a fatty acid and a catalyst into a stirring tank type reactor and heating the mixture to a prescribed temperature with continued stirring, distilling the produced water out of the reaction system. The reaction time is usually 3 to 10 hours.

Preferably an inert gas such as nitrogen gas is kept passed into the gas phase portion of the reactor throughout the reaction.

The molar ratio of the fatty acid to polyglycerin is usually not less than 0.4 but not more than 1.5, preferably not less than 0.6 but not more than 1.2, more preferably not less than 0.8 but not more than 1.0.

The reaction is usually carried out by supplying polyglycerin, a fatty acid and a catalyst into a stirring tank type reactor and heating the mixture to a prescribed temperature with continued stirring, distilling the produced water out of the reaction system. Preferably an inert gas such as nitrogen gas is kept passed into the gas phase portion of the reactor throughout the reaction.

[Emulsifying or Solubilizing Agent Comprising a Polyglycerin Fatty Acid Ester]

In the emulsifying or solubilizing agent comprising a polyglycerin fatty acid ester according to the present invention, it is possible to blend, beside a polyglycerin fatty acid ester such as mentioned above, other types of fatty acid esters such as glycerin fatty acid ester, sucrose fatty acid ester, propylene glycol fatty acid ester, lecithin, sorbitan fatty acid ester, monoglyceride organic acid esters and their alkali metal salts, fatty acid/lactic acid esters and their alkali metal salts, etc., of which monoglyceride organic acid esters and their alkali metal salts and fatty acid/lactic acid esters and their alkali metal salts are especially preferred for use as additional components because they can serve for inhibiting gelation of the emulsifying or solubilizing agent.

As the component organic acid of the monoglyceride organic acid esters, lactic acid, citric acid, succinic acid and diacetyltartaric acid can be cited as examples. The component fatty acid may be either a saturated or unsaturated one with a carbon number of 8 to 18, but the unsaturated one is preferred. Oleic acid monoglyceride citric acid ester is especially preferred as this type of ester. As the fatty acid/lactic acid esters, their component fatty acid may be either saturated or unsaturated one with a carbon number of 8 to 18, but lactic acid/stearic acid ester sodium salts are especially preferred. As the alkali metal, sodium and potassium can be mentioned. The content of the ionic emulsifier such as monoglyceride organic acid ester, fatty acid/lactic acid ester or their alkali metal salt in the emulsifying or solubilizing agent according to the present invention is usually not less than 0.01% by weight but not more than 20% by weight, preferably not less than 0.05% by weight but not more than 10% by weight, more preferably not less than 1% by weight but not more than 5% by weight.

The content of the said polyglycerin fatty acid ester in the emulsifying or solubilizing agent according to the present invention is usually not less than 20% by weight but not more than 100% by weight, preferably not less than 40% by weight but not more than 100% by weight, more preferably not less than 60% by weight but not more than 100% by weight.

[Emulsified or Solubilized Preparations]

The emulsified or solubilized preparations of the present invention comprises a polyglycerin fatty acid ester such as mentioned above, a nonaqueous substance, a polyhydric alcohol and/or water. The emulsified or solubilized preparations according to the present invention are the compositions which have been emulsified or solubilized, and can serve as a base material for the emulsified or solubilized compositions to be described later. The “solubilized composition” referred to in the present invention means a solution which is transparent in visual appearance, more specifically a homogeneous solution whose transmittance at 650 nm is not less than 50%, which includes a solution which was made transparent in visual appearance by fine emulsification.

(Nonaqueous Substances)

The nonaqueous components usable in the present invention include, for example, colorants, flavoring agents, essential oils, oleoresin or resinoid, waxes, fatty acids and their esters with alcohols, vitamins, antioxidants, saturated or unsaturated higher alcohols, hydrocarbons, preservatives, sterilizers, and animal and plant oils and fats.

Examples of the colorants are β-carotene, paprika pigment, annatto pigment, safrole yellow, riboflavin, lac pigment, curcumin, chlorophyll, and turmeric pigment.

Examples of the flavoring agents usable in the present invention include orange oil, lemon grass oil, tarragon oil, avocado oil, laurel leave oil, cassia oil, cinnamon oil, pepper oil, calamus oil, sage oil, mint oil, peppermint oil, spearmint oil, patchouli oil, rosemary oil, lavandine oil, lavender oil, curcuma oil, cardamom oil, ginger oil, angelica oil, anise oil, fennel oil, parsley oil, celery oil, galbanum oil, cumin oil, coriander oil, dill oil, carrot oil, caraway oil, wintergreen oil, nutmeg oil, rose oil, cypress oil, sandalwood oil, allspice, grapefruit oil, neroli oil, lemon oil, lime oil, bergamot oil, mandarin oil, onion oil, garlic oil, bitter almond oil, geranium oil, mimosa oil, jasmine oil, fragrant olive oil, staranise oil, cananga oil, ylang-ylang oil, eugenol oil, ethyl caprylate, geraniol, menthol, citral, citronellal, and borneol.

Examples of the essential oils include ambrette seed oil, mustard oil, saffron oil, citronella oil, vetiver oil, valerian oil, mugwort oil, camomile oil, camphor oil, sassafras oil, hosho oil, rosewood oil, clary sage oil, thyme oil, basil oil, carnation oil, cedarwood oil, hinoki oil, hiba oil, clove oil, turpentine oil, and pine oil.

Examples of the oleoresin or resinoid include pepper, cardamom, ginger, parsley, coriander, caraway, pimento, vanilla, celery, clove, nutmeg, paprika, orris resinoid and olibanum.

As examples of the waxes, jojoba oil, rice wax, propolis, bee wax, haze wax, candelilla wax, carnauba wax, Japan wax, whale wax, seresin and such can be mentioned.

Examples of the fatty acids and their esters with alcohols include hexadecatrienoic acid, octadecatrienoic acid, eicosatetraenoic acid, docosatetraenoic acid, eicosapentaenoic acid, docosapentaenoic acid, docosahexaenoic acid, tetrahexaenoic acid, their geometric isomers, and their esters with alcohols.

Exemplary of the vitamins usable in the present invention are vitamin A, vitamin D, vitamin E and vitamin K.

Examples of the antioxidants include ascorbic acid esters, dl-α-tocopherol, dibutylhydroxytoluene, butylhydroxyanisole, pagoda-tree extract, γ-oryzanol, clove extract, catechins, gentisin oil, gossypetin, rice bran oil unsaponifiables, sesamolin, sesamol, sage extract, natural vitamin E, pimento extract, pepper extract, gallic acid derivatives, eucalyptus leave extract, and rosemary extract.

Exemplary of the saturated or unsaturated higher alcohols are the alcohols with a carbon number of 8 to 44 such as lauryl alcohol, myristyl alcohol, cetanol, stearyl alcohol, oleyl alcohol, laurin alcohol, isostearyl alcohol, and 2-octyldodecanoloctacosanol.

Examples of the hydrocarbons include soft liquid paraffin, heavy liquid paraffin, liquid isoparaffin, soft liquid isoparaffin, ceresine, paraffin, macrocrystalline wax, vaseline, squalane, and squalene.

A typical example of the preservatives and sterilizers is dehydroacetic acid.

Examples of the animal and plant oils and fats include safflower oil, soybean oil, corn oil, cotton seed oil, rapeseed oil, sesame oil, rice oil, sunflower oil, peanut oil, olive oil, palm oil, palm kernel oil, camellia oil, coconut oil, castor oil, linseed oil, cacao oil, milk fat, middle-chain fatty acid triglyceride, tallow, lard, and fish oil.

The above respective components may be used either alone or as a combination of two or more.

(Polyhydric Alcohols)

The emulsified or solubilized preparations according to the present invention contain at least one of a polyhydric alcohol and water, or may contain both of them.

Examples of the polyhydric alcohols usable in the present invention include propylene glycol, glycerin, sorbitol, xylitol, arabitol, maltitol, lactitol, sorbitan, xylose, arabinose, mannose, lactose, sugar, coupling sugar, dextrose, enzyme syrup, acid converted syrup, maltose syrup, maltose, isomerized syrup, fructose, reduced maltose syrup, reduced starch sugar syrup, and honey.

(Water)

Water used in the present invention may be desalted or ordinary tap water which may or may not contain food additives. Preferably a monoglyceride organic acid ester, a fatty acid/ lactic acid ester or its alkali metal salt is contained in the water.

(Other Components)

The emulsified or solubilized preparations according to the present invention may contain where necessary a surfactant, ethanol, stabilizer, and food additives such as seasonings, acids and salts. It is preferable to contain an ionic emulsifying agent such as the above-mentioned monoglyceride organic acid esters and their alkali metal salts and fatty acid/lactic acid esters and their alkali metal salts because this agent is helpful for preventing gelation of the solution.

(Compositions of Emulsified or Solubilized Preparations)

The emulsified or solubilized preparations according to the present invention comprises a polyglycerin fatty acid ester in an amount of usually not less than 0.1% by weight but usually less than 90% by weight, less than 50% by weight, more preferably less than 20% by weight.

A nonaqueous substance is added in an amount of usually not less than 0.1% by weight but usually less than 90% by weight, preferably less than 50% by weight, more preferably less than 20% by weight.

A polyhydric alcohol is added in an amount of usually not less than 0% by weight, preferably not less than 50% by weight, more preferably not less than 80% by weight but usually less than 99.8% by weight.

Water is added in an amount of usually not less than 0% by weight but usually less than 99.8% by weight, preferably less than 50% by weight, more preferably less than 20% by weight.

The content of the ionic emulsifying agent such as a monoglyceride organic acid ester, a fatty acid/lactic acid ester or its alkali metal salt is usually not less than 1×10⁻⁵% by weight, preferably not less than 5×10⁻⁵% by weight, more preferably not less than 0.001% by weight but usually less than 18% by weight, preferably less than 5% by weight, more preferably less than 1% by weight.

The nonaqueous substance/(nonaqueous substance+PoGE) ratio by weight is usually not less than 0.001 but less than 1, the nonaqueous substance/(nonaqueous substance+polyhydric alcohol and/or water) ratio by weight is usually not less than 0.001 but less than 1, and the polyhydric alcohol/(water+polyhydric alcohol) ratio by weight is usually not less than 0 but less than 1.

(Production of Emulsified or Solubilized Preparations)

The emulsified or solubilized preparations can be produced by mixing the component materials and stirring the mixture by the known ordinary methods. For example, they can be produced by using an emulsifier such as homomixer or a high-pressure homogenizer. It is also possible to produce such preparations by dissolving a polyglycerin fatty acid ester (or an emulsifying or solubilizing agent such as mentioned above) and a polyhydric alcohol and/or water at 40 to 80° C., then mixing a nonaqueous substance therewith and subjecting the mixture to an emulsification treatment.

[Emulsified or Solubilized Compositions]

When an emulsified or solubilized composition is made by diluting an emulsified or solubilized preparation such as mentioned above with an aqueous medium, a finely emulsified composition having a good flavor and capable of maintaining high transmittance even under an acid condition can be obtained, and there is no possibility for the polyglycerin fatty acid ester itself to precipitate during preservation of the composition. The aqueous medium used here is water, an alcohol such as ethanol or a mixture thereof, and may contain a sugar such as sucrose or an organic acid such as citric acid depending on the intended use of the composition.

By blending soft drinks such as refreshing drinks (carbonated drinks, coffee drinks, fruit drinks, oolong tea, black tea, green tea, barley water, mineral water, soybean milk, vegetable drinks, cocoa drinks, etc.), milk and milk-based drinks (fermented milk drinks, lactic acid beverages, etc.), sports drinks, supplement drinks, protein drinks, nutritious drinks, etc., alcoholic drinks, and acid drinks; bread and confectionary such as bread, biscuit, jerry, mousse, cakes, chocolate, chewing gum, etc.; fruit jam and preserves; fish-paste products such as kamaboko (boiled fish paste), hanpen (a cake of pounded fish), chikuwa (a kind of fish paste), fish meat ham, sausage, etc.; livestock products such as ham, bacon, corn beef, etc,; pickles, tsukudani (food boiled down in soy) and foods of delicate flavor; various kinds of sauce; seasonings, etc., in the emulsified or solubilized preparations produced by using polyglycerin fatty acid esters according to the present invention, it is possible to obtain drinks and foods (emulsified or solubilized compositions) which can maintain their fragrance, flavor, color and visual appearance in a stabilized way for a long time.

The contents of the respective components in the emulsified or solubilized compositions according to the present invention are as follows: polyglycerin fatty acid ester is usually not less than 0.001% by weight but less than 50% by weight, nonaqueous substance is usually not less than 0.001% by weight but less than 50% by weight, polyhydric alcohol is usually not less than 0.001% by weight but less than 50% by weight, and water is usually not less than 50% by weight but less than 99.9% by weight.

The content of the ionic emulsifying agent such as monoglyceride fatty acid ester, fatty acid/lactic acid ester and their alkali metal salts is usually not less than 1×10⁻⁷% by weight but not more than 10% by weight.

The nonaqueous substance/(nonaqueous substance+PoGE) ratio by weight is usually not less than 0.001 but less than 1, the nonaqueous substance/(nonaqueous substance+polyhydric alcohol and/or water) ratio by weight is usually not less than 0.00001 but less than 0.9, and the polyhydric alcohol/(water+polyhydric alcohol) ratio by weight is usually not less than 0 but less than 0.5.

The solubilized compositions of the present invention preferably have as high transmittance as possible. Their transmittance at 650 nm is preferably not less than 60%, more preferably not less than 80%, even more preferably not less than 90%.

### EXAMPLES

The present invention will be further illustrated by the following embodiments, but these embodiments are merely intended to be illustrative and not to be construed as limiting the scope of the invention. The cloud point of the polyglycerin fatty acid esters used in the following Examples and the Comparative Examples was determined by the method described below.

[Determination of Cloud Point of PoGE's]

Each PoGE was dissolved in a previously prepared 7 wt % sodium sulfate solution to a PoGE concentration of 1% by weight, and this solution was put into a glass tube and sealed. This glass tube was heated and shaken to make the solution homogeneous, and then it was dipped in a thermostatic tank set at a specified temperature. After allowing the solution to stand for several minutes to one hour, the solution in the glass tube was visually observed to see whether separation of the solution took place or not. The above operation was repeated by elevating the thermostatic tank temperature stepwise 5° C. each time, and the temperature intermediate between the temperature at which PoGE was separated for the first time to make the solution cloudy and the highest temperature at which the solution could remain homogeneous was expressed as cloud point.

### Production Example 1

### Production of PoGE-A

First, 1,200 g of PoG (average polymerization degree: 10) was supplied to a 2-litre reactor equipped with a stirrer, a thermometer, a heating jacket, a gas feed port and a material feed port. Then palmitic acid (purity: 99%) and a 10% aqueous sodium hydroxide solution were supplied to the same reactor. Feed of palmitic acid was adjusted so that the palmitic acid/PoG molar ratio would become 1/1. Sodium hydroxide was added in a ratio of 0.375% by weight to the total amount of PoG and fatty acid. The mixture was heated to an internal temperature of 240° C. under normal pressure in a stream of nitrogen and reacted at this temperature for 5 hours. After completion of the reaction, the internal temperature was lowered down to normal temperature to obtain a polyglycerin palmitic acid ester (PoGE-A). Cloud point of the obtained reaction product was determined by the method described above. Results are shown in Table 1.

### Production Example 2

### Production of PoGE-B

1,200 g of PoG (average polymerization degree: 10) was supplied to a 2-litre reactor furnished with a stirrer, a thermometer, a heating jacket, a gas feed port and a material feed port, and then palmitic acid (purity: 99%) and a 10% aqueous sodium hydroxide solution were supplied to the same reactor. Feed of palmitic acid was adjusted so that the palmitic acid/PoG molar ratio would become 1/1. Sodium hydroxide was added in a ratio of 0.0025% by weight to the total amount of PoG and fatty acid. The mixture was heated to an internal temperature of 240° C. under normal pressure in a stream of nitrogen and reacted at this temperature for 3 hours, after which the internal temperature was further raised to 260° C., allowing the mixture to react at this temperature for 4 hours. After completion of the reaction, the internal temperature was lowered down to normal temperature to obtain a polyglycerin palmitic acid ester (PoGE-B). Cloud point of the obtained reaction product was determined by the method described above. Results are shown in Table 1.

### Production Example 3

### Production of PoGE-C

A polyglycerin palmitic acid ester (PoGE-C) was obtained in the same way as in Production Example 2 except that the feed of palmitic acid was adjusted so that the palmitic acid/PoG molar ratio would become 0.8/1. Cloud point of the obtained reaction product was determined by the method described above. Results are shown in Table 1.

### Production Example 4

### Production of PoGE-D

A polyglycerin palmitic acid ester (PoGE-D) was obtained in the same way as in Production Example 2 except that the feed of palmitic acid was adjusted so that the palmitic acid/PoG molar ratio would become 1.5/1. Cloud point of the obtained reaction production was determined by the method described above. Results are shown in Table 1.

### Production Example 5

### Production of PoGE-E

A polyglycerin myristic acid ester (PoGE-E) was obtained in the same way as in Production Example 1 except that myristic acid (purity: 99%) was used in place of palmitic acid as fatty acid.

### Production Example 6

### Production of PoGE-F

A polyglycerin palmitic acid/stearic acid ester (PoGE-F) was obtained in the same way as in Production Example 1 except that a mixture of 60% palmitic acid and 40% steartic acid was used in place of palmitic acid as fatty acid. Cloud point of the obtained reaction product was determined by the method described above. Results are shown in Table 1.

### Production Example 7

### Production of PoGE-G

A polyglycerin oleic acid ester (PoGE-G) was obtained in the same way as in Production Example 2 except that oleic acid was used in place of palmitic acid as fatty acid.

### Example 1

To 120 g of glycerin, 8 g of PoGE-A was added as a polyglycerin fatty acid ester and dissolved, to which 8 g of middle chain triglyceride (MCT) was further added and the mixture was stirred by a homomixer at 3,000 rpm for 30 minutes to obtain 136 g of a solubilized preparation. 0.17 g of this solubilized preparation was mixed and stirred with 19.83 g of a 0.1% citric acid solution to obtain a homogeneous dilute solution (final solubilized composition), which was then subjected to a sterilization treatment by heating at 90° C. for 10 minutes.

After allowing the solution to stand at 25° C. for a day, transmittance of this dilute solution at 650 nm was measured at room temperature by Shimadzu UV-1200. An organoleptic test by a specialist panel was conducted on the smell of this dilute solution. It was also checked whether there was produced any precipitate in the solution or not after preserving the solution at 5° C. for one week.

### Example 2

The same procedure as defined in Example 1 was conducted except for use of PoGE-B as polyglycerin fatty acid ester.

### Example 3

The same procedure as defined in Example 1 was conducted except for use of PoGE-C as polyglycerin fatty acid ester.

### Example 4

The same procedure as defined in Example 1 was conducted except that a composition obtained by mixing 3% by weight of an oleic monoglyceride citric acid ester with PoGE-C was used in place of PoGE-A. The solubilized preparation produced by using this composition did not gel even after preservation at 5° C. for one month.

### Comparative Example 1

The same procedure as defined in Example 1 was conducted except for use of PoGE-D as polyglycerin fatty acie ester.

### Comparative Example 2

The same procedure as defined in Example 1 was conducted except for use of PoGE-E as polyglycerin fatty acid ester.

### Comparative Example 3

The same procedure as defined in Example 1 was conducted except for use of PoGE-F as polyglycerin fatty acid ester.

### Comparative Example 4

The same procedure as defined in Example 1 was conducted except for use of PoGE-G as polyglycerin fatty acid ester.

The results of Examples 1 to 3 and Comparative Examples 1 to 4 are shown in Table 1.

TABLE 1

| | | Average | |
|---|---|---|---|
| | Emulsifying | polymerization degree | Cloud point |
| | agent | of component PoG | of PoGE (° C.) |
| Example 1 | PoGE-A | 10 | 92.5 |
| Example 2 | PoGE-B | 10 | 77.5 |
| Example 3 | PoGE-C | 10 | 82.5 |
| Example 4 | PoGE-C | 10 | 82.5 |
| Comp. | PoGE-D | 10 | 52.5 |
| Example 1 | | | |
| Comp. | PoGE-E | 10 | >95 |
| Example 2 | | | |
| Comp. | PoGE-F | 10 | 72.5 |
| Example 3 | | | |
| Comp. | PoGE-G | 10 | 82.5 |
| Example 4 | | | |

| | Transmittance | Smell of | Visual appearance of |
|---|---|---|---|
| | at 650 nm of | emulsified | dilute solution |
| | dilute | dilute | after preservation at |
| | solution (%) | solution | 5° C. for one week |
| Example 1 | 91.3 | None | No precipitation |
| Example 2 | 68.3 | None | No precipitation |
| Example 3 | 81.2 | None | No precipitation |
| Example 4 | 79.6 | None | No precipitation |
| Comp. | 15.8 | None | Precipitation |
| Example 1 | | | occurred |
| Comp. | 2.8 | None | No precipitation |
| Example 2 | | | |
| Comp. | 91.3 | None | Precipitation |
| Example 3 | | | occurred |
| Comp. | 44.6 | Present | No precipitation |
| Example 4 | | | |

From the results shown in Table 1, it can be seen that the dilute solutions of Examples 1 to 4 have high transmittance, are quite satisfactory in flavor and produce no precipitate during preservation at low temperatures. In contrast, it is noted that the dilute solutions of the Comparative Examples have a problem in at least one of flavor, transmittance and formation of precipitates during preservation at low temperatures.

1-8. (canceled)

9. Polyglycerin fatty acid esters whose constituting fatty acid comprises not less than 70% by weight of palmitic acid and whose cloud point in a 7 wt % Na₂SO₄ solution at a concentration of 1 % by weight is not lower than 55° C. but not higher than 100° C.

10. Polyglycerin fatty acid esters according to claim 9, wherein the average polymerization degree of the component polyglycerin is not more than 17.

11. An emulsifying agent comprising a polyglycerin fatty acid ester as defined in claim 9.

12. An emulsifying agent comprising a polyglycerin fatty acid ester as defined in claim 10.

13. A solubilizing agent comprising a polyglycerin fatty acid ester as defined in claim 9.

14. A solubilizing agent comprising a polyglycerin fatty acid ester as defined in claim 10.

15. An emulsified preparation comprising a polyglycerin fatty acid ester as defined in claim 9, a nonaqueous substance and a polyhydric alcohol and/or water.

16. An emulsified preparation comprising a polyglycerin fatty acid ester as defined in claim 10, a nonaqueous substance and a polyhydric alcohol and/or water.

17. A solubilized preparation comprising a polyglycerin fatty acid ester as defined in claim 9, a nonaqueous substance and a polyhydric alcohol and/or water.

18. A solubilized preparation comprising a polyglycerin fatty acid ester as defined in claim 10, a nonaqueous substance and a polyhydric alcohol and/or water.

19. An emulsified composition comprising a polyglycerin fatty acid ester as defined in claim 9, a nonaqueous substance and a polyhydric alcohol and/or water.

20. An emulsified composition comprising a polyglycerin fatty acid ester as defined in claim 10, a nonaqueous substance and a polyhydric alcohol and/or water.

21. A solubilized composition comprising a polyglycerin fatty acid ester as defined in claim 9, a nonaqueous substance and a polyhydric alcohol and/or water.

22. A solubilized composition comprising a polyglycerin fatty acid ester as defined in claim 10, a nonaqueous substance and a polyhydric alcohol and/or water.
